(19) United States
(12) Patent Application Publication
(10) Pub. No.: US 2009/0105946 A1
(43) Pub. Date: Apr. 23, 2009

(54) METHOD FOR PROVIDING NAVIGATION BACKGROUND INFORMATION AND NAVIGATION SYSTEM USING THE SAME

(75) Inventor: Ji Su Jang, Seoul (KR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: THINKWARE SYSTEMS CORPORATION, Seoul (KR)

(21) Appl. No.: 12/298,470

(22) PCT Filed: Jan. 26, 2007
(86) PCT No.: PCT/KR07/00465

§ 371 Date: Oct. 24, 2008

(30) Foreign Application Priority Data
Apr. 27, 2006 (KR) 10-2006-0038215

(51) Int. Cl. G01C 21/32

(52) U.S. Cl. 701/208

(57) ABSTRACT

A navigation system, including: a peak point database storing corresponding location information for each peak identifier (ID); a distance/angle computation unit computing distance information and angle information between a vehicle and a peak by referring to the peak point database and current location information of the vehicle; an image loading unit loading an image corresponding to the peak ID from a predetermined image database, when the computed distance information and angle information are included in a predetermined distance range and a predetermined visual field angle; an image control unit controlling the loaded image based on a distance between the vehicle and the peak; and a background information generation unit generating navigation background information including the controlled image.

### TECHNICAL FIELD

The present invention relates to a navigation system providing navigation background information, and more particularly, to a method of providing navigation background information and a navigation system using the same which include an image of an existing peak in navigation background information by referring to distance information and angle information between a location of a peak and a current location of a vehicle, and thereby may provide the navigation background information in a more realistic manner.

### BACKGROUND ART

Navigation systems are systems to provide navigation information for driving of vehicles, such as cars, using satellites. The navigation systems are referred to as automatic navigation systems. Recently, navigation systems provide navigation services, and also a variety of services such as a wireless Internet, video, and call services.

Also, due to the development of communication technologies, communication terminals such as cellular phones, personal digital assistants (PDAs), and the like, may provide users with such navigation services. Accordingly, the use of navigation systems has been gradually increasing.

Users of such navigation systems may search for location information through different types of searches such as name searches, address searches, phone number searches, business category searches, and the like. Also, navigation systems may direct routes through starting locations, intermediate locations, and destinations, designated by users, via map searches. Moreover, navigation systems may enable users to conveniently drive and walk with audio-guided routes according to users' actual driving routes. Accordingly, the number of users of navigation systems has been increasing.

Also, navigation information provided by navigation systems includes navigation backgrounds such as roads, buildings, rivers, mountains, and the like. In navigation systems in a conventional art, mountain images of navigation backgrounds included in navigation information is displayed for using unused space of screen or improving images with respect to navigation systems regardless of mountains which actually exist.

However, navigation systems in the conventional art include and provide images of mountains, which do not actually exist, in navigation backgrounds, and thereby causes low reality. Also, navigation systems in the conventional art may not provide information about actually existing mountains. Accordingly, a method of providing an image of an existing mountain as a navigation background is required.

### DISCLOSURE OF INVENTION

### Technical Goals

The present invention provides a method of providing navigation background information and a navigation system using the same which load an image with respect to a peak, included in a predetermined distance range and a predetermined visual field angle, by referring to a current location of a vehicle and location information about each peak, include the image in the navigation background information, and thereby may provide the navigation background information in a more realistic manner.

The present invention also provides a method of providing navigation background information and a navigation system using the same which control an image with respect to a peak, included in the navigation background information, to be displayed with perspective, based on a distance between a vehicle and the peak, and thereby may provide navigation background information in a more realistic manner.

### Technical Solutions

According to an aspect of the present invention, there is provided a navigation system, including: a peak point database storing corresponding location information for each peak identifier (ID); a distance/angle computation unit computing distance information and angle information between a vehicle and a peak by referring to the peak point database and current location information of the vehicle; an image loading unit loading an image corresponding to the peak ID from a predetermined image database, when the computed distance information and angle information are included in a predetermined distance range and a predetermined visual field angle; an image control unit controlling the loaded image based on a distance between the vehicle and the peak; and a background information generation unit generating navigation background information including the controlled image.

In this instance, the image control unit controls a height of the image or controls a predetermined portion of the image to be displayed, based on the distance between the vehicle and the peak.

According to another aspect of the present invention, there is provided a method of providing navigation background information, the method including: maintaining a peak point database storing corresponding location information for each peak ID; computing distance information and angle information between a vehicle and a peak by referring to the peak point database and current location information of the vehicle; loading an image corresponding to the peak ID from a predetermined image database, when the computed distance information and angle information are included in a predetermined distance range and a predetermined visual field angle; controlling the loaded image based on a distance between the vehicle and the peak; and generating navigation background information including the controlled image.

### BRIEF DESCRIPTION OF DRAWINGS

FIG. 1 is a block diagram illustrating a configuration of a navigation system according to an embodiment of the present invention;

FIG. 2 is a diagram illustrating an example of location information stored in a peak point database according to an embodiment of the present invention;

FIG. 3 is a diagram illustrating an example of computing distance information and angle information between a vehicle and a peak according to an embodiment of the present invention;

FIG. 4 is a diagram illustrating an operation of an image loading unit according to an embodiment of the present invention;

FIG. 5 is a diagram illustrating an example of an image database according to an embodiment of the present invention;

FIG. 6 is a diagram illustrating an example of navigation background information which is provided as a portion of navigation information according to an embodiment of the present invention; and

FIG. 7 is a flowchart illustrating a method of providing navigation background information according to an embodiment of the present invention.

### BEST MODE FOR CARRYING OUT THE INVENTION

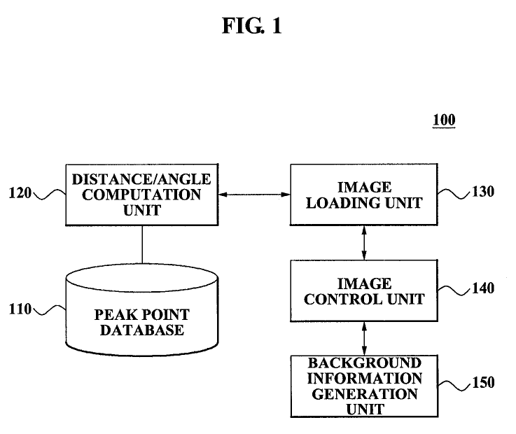

FIG. 1 is a block diagram illustrating a configuration of a navigation system according to an embodiment of the present invention.

Referring to FIG. 1, the navigation system 100 includes a peak point database 110, a distance/angle computation unit 120, an image loading unit 130, an image control unit 140, and a background information generation unit 150.

According to an embodiment of the present invention, the navigation system 100 may be included in a navigation providing server, a cellular phone, and the like, which provide a navigation service by being connected via a communication network.

The peak point database 110 stores corresponding location information for each peak identifier (ID). According to the present invention, the peak ID may be identification information identifying each peak. As an example, the peak point database 110 may store location information corresponding to ‘Nam mountain’ which is the peak ID.

According to an embodiment of the present invention, the location information stored in the peak point database 110 may be generated using point information about an altitude point of a peak by referring to a contour line data of the peak.

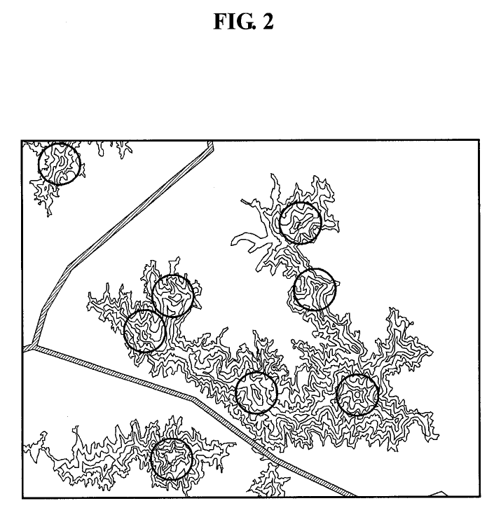

FIG. 2 is a diagram illustrating an example of location information referred to in a peak point database according to an embodiment of the present invention Referring to FIG. 2, location information stored in a peak point database 110 is generated using an altitude point corresponding to each peak by referring to contour line data of each peak. Also, the location information may be stored in the peak point database 110 by corresponding to a peak ID. The peak ID identifies each peak. As an example, the location information may include coordinate information of a latitude and a longitude of the altitude point corresponding to the each peak.

A distance/angle computation unit 120 computes distance information and angle information between a vehicle and a peak by referring to the peak point database 110 and current location information of the vehicle.

According to an embodiment of the present invention, the distance/angle computation unit 120 may compute the distance information and the angle information between the vehicle and the peak by considering a driving direction of the vehicle.

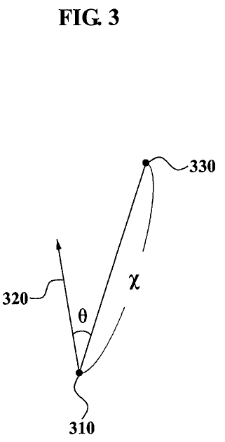

FIG. 3 is a diagram illustrating an example of computing distance information and angle information between a vehicle and a peak according to an embodiment of the present invention.

Referring to FIG. 3, a distance/angle computation unit 120 may compute distance information ‘λ’ and angle information ‘θ’ between a vehicle 310 and a peak 330 by considering a driving direction 320 of the vehicle 310. In FIG. 3, although the distance information ‘λ’ and the angle information ‘θ’ between the vehicle 310 and the peak 330 are computed with respect to only a single peak, the distance/angle computation unit 120 may compute distance information and angle information between the vehicle 310 and at least one peak corresponding to a peak ID from among all peaks in a peak point database 110. As an example, the distance/angle computation unit 120 may compute distance information and angle information between the vehicle 310 and each peak with respect to at least one peak which exists in a predetermined range, based on current location information of the vehicle 310.

An image loading unit 130 loads an image corresponding to the peak ID from a predetermined image database, when the computed distance information ‘λ’ and the computed angle information ‘θ’ are included in a predetermined distance range and a predetermined visual field angle.

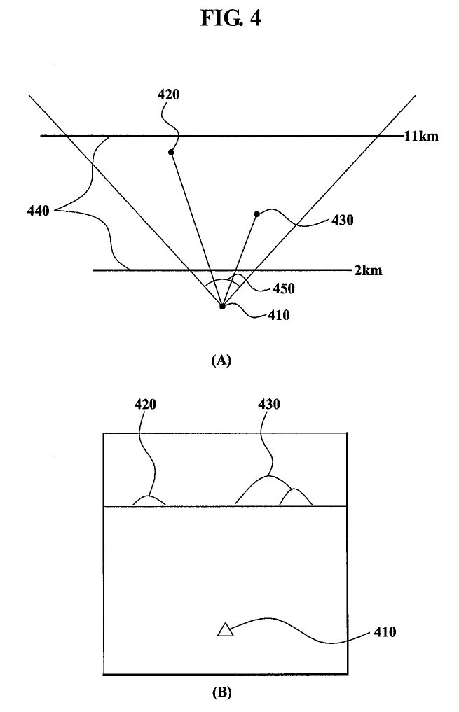

FIG. 4 is a diagram illustrating an operation of an image loading unit according to an embodiment of the present invention.

Referring to FIG. 4, the image loading unit 130 may load an image corresponding to a peak ID from an image database, when distance information and angle information between a vehicle 410 and each peak 420 and 430 are included in a predetermined distance range 440 and a predetermined visual field angle 450. In this instance, the distance information and the angle information are computed in a distance/angle computation unit 120.

According to an embodiment of the present invention, the image loading unit 130 may include at least one peak ID, included in the predetermined distance range 440 and the predetermined visual field angle 450, in a display list. Also, the image loading unit 130 may load an image corresponding to the at least one peak ID, included in the display list, from the image database in an order of farthest to nearest distance. According to the present invention, the display list may be a list of background information included in navigation background information.

According to another embodiment of the present invention, the image database generates and stores the image for each peak ID.

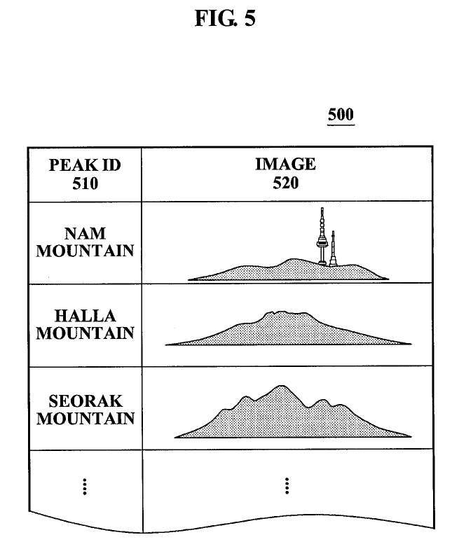

FIG. 5 is a diagram illustrating an example of an image database according to an embodiment of the present invention.

Referring to FIG. 5, the image database 500 includes a peak ID field 510 and an image field 520. The peak ID field 510 may store identification information identifying each peak. The image field 520 may store an image by corresponding one-to-one to the peak ID field 510. As an example, the image stored in the image field 520 may be graphical information or photo information which is similar to an actual mountain corresponding to each peak.

An image control unit 140 controls perspectives/properties of a loaded image based on a distance between a vehicle and a peak.

According to an embodiment of the present invention, the image control unit 140 may control a height of the image based on the distance between the vehicle and the peak. As an example, when the distance between the vehicle and the peak is equal to or greater than a predetermined distance, based on the distance between the vehicle and the peak, the image control unit 140 controls the height of the image to be reduced. Also, when the distance between the vehicle and the peak is less than the predetermined distance, the image control unit 140 controls the height of the image to be increased. Specifically, when the distance between the vehicle and the peak is equal to or greater than a predetermined distance, the image control unit 140 may display an image which is located far away by controlling the height of the image to be lowered. Also, when the distance between the vehicle and the peak is less than the predetermined distance, the image control unit 140 may display an image which is located nearby by controlling the height of the image to be raised.

Also, according to an embodiment of the present invention, the image control unit 140 may control a predetermined portion of the image to be displayed, based on the distance between the vehicle and the peak.

According to an embodiment of the present invention, based on the distance between the vehicle and the peak, the image control unit 140 controls an upper portion of the image to be displayed when the distance between the vehicle and the peak is equal to or greater than the predetermined distance. Also, the image control unit 140 controls the entire image to be displayed when the distance between the vehicle and the peak is less than the predetermined distance. Specifically, the image control unit 140 may add perspective to the image, which is displayed in a navigation background by controlling the predetermined portion of the image to be displayed.

As an example, referring again to FIG. 4, the image control unit 140 may control an upper portion of an image of the peak 420 to be displayed. In this instance, the peak 420 is located further away than the peak 430 in association with the vehicle 410. Also, the image control unit 140 may control an entire image of the peak 430 to be displayed. In this instance, the peak 430 is located closer than the peak 420 in association with the vehicle 410.

A background information generation unit 150 generates navigation background information including the controlled image. According to an embodiment of the present invention, the navigation background information may be provided as a portion of navigation information associated with the vehicle 410.

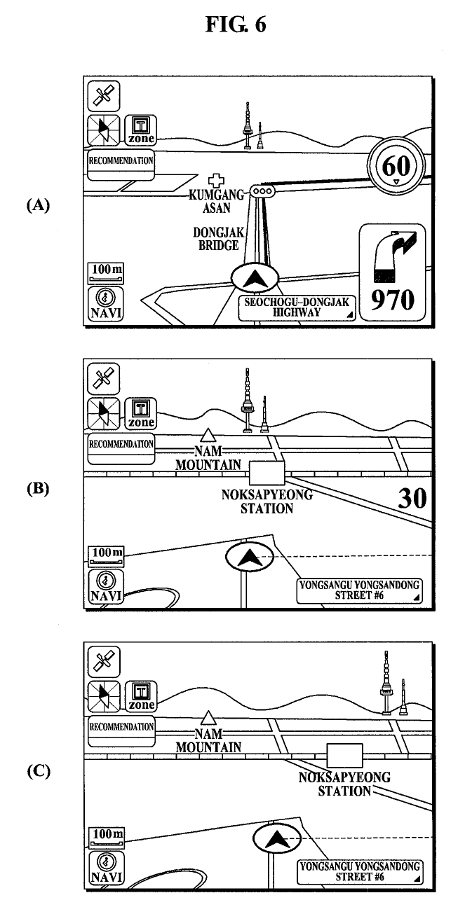

FIG. 6 is a diagram illustrating an example of navigation background information which is provided as a portion of navigation information according to an embodiment of the present invention.

Referring to FIG. 6, a navigation system includes an image, which is controlled based on a distance between a vehicle and a peak, in the navigation background information. Also, the navigation background information may be provided as a portion of the navigation information.

Also, according to another embodiment of the present invention, a background information generation unit 150 may display a corresponding image according to an order by including the image in the navigation background information. In this instance, the order refers to an order of loading an image corresponding to a peak ID in an order of farthest to nearest distance.

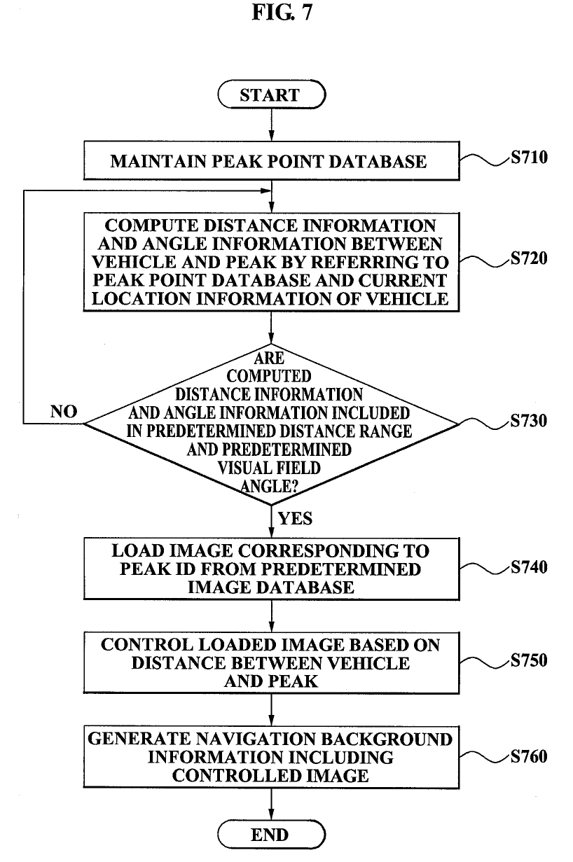

FIG. 7 is a flowchart illustrating a method of providing navigation background information according to an embodiment of the present invention.

Referring to FIG. 7, in operation S710, the method of providing navigation background information maintains a peak point database. The peak point database stores corresponding location information for each peak ID. According to an embodiment of the present invention, the peak ID may be identification information identifying each peak.

According to an embodiment of the present invention, the location information stored in the peak point database may be generated using point information about an altitude point of a peak by referring to a contour line data of the peak.

In operation S720, the method of providing navigation background information computes distance information and angle information between a vehicle and a peak by referring to the peak point database and current location information of the vehicle.

According to an embodiment of the present invention, the method of providing navigation background information may compute distance information and angle information between the vehicle and each peak with respect to at least one peak which exists in a predetermined range, based on the current location information of the vehicle.

According to another embodiment of the present invention, the method of providing navigation background information may compute the distance information and the angle information between the vehicle and the peak by considering a driving direction of the vehicle.

In operation S730, the method of providing navigation background information determines whether the computed distance information and angle information are included in a predetermined distance range and a predetermined visual field angle.

In operation S740, when the computed distance information and angle information are included in the predetermined distance range and the predetermined visual field angle as a result of the determining in operation S730, the method of providing navigation background information loads an image corresponding to the peak ID from a predetermined image database.

According to an embodiment of the present invention, the image database may generate and store the image for each peak ID.

Also, according to another embodiment of the present invention, the method of providing navigation background information includes at least one peak ID, included in the predetermined distance range and the predetermined visual field angle, in a display list. Also, the method of providing navigation background information may load an image corresponding to the at least one peak ID, included in the display list, in an order of farthest to nearest distance.

In operation S750, the method of providing navigation background information controls the loaded image based on a distance between the vehicle and the peak.

According to an embodiment of the present invention, the method of providing navigation background information may control a height of the image based on the distance between the vehicle and the peak. As an example, when the distance between the vehicle and the peak is equal to or greater than a predetermined distance, the method of providing navigation background information controls the height of the image to be reduced. Also, when the distance between the vehicle and the peak is less than the predetermined distance, the method of providing navigation background information controls the height of the image to be increased.

Also, according to another embodiment of the present invention, the method of providing navigation background information may control a predetermined portion of the image to be displayed, based on the distance between the vehicle and the peak.

According to an embodiment of the present invention, the method of providing navigation background information controls an upper portion of the image to be displayed when the distance between the vehicle and the peak is equal to or greater than the predetermined distance. Also, the method of providing navigation background information controls the entire image to be displayed when the distance between the vehicle and the peak is less than the predetermined distance.

In operation S760, the method of providing navigation background information generates navigation background information including the controlled image.

According to an embodiment of the present invention, the navigation background information is provided as a portion of navigation information associated with the vehicle.

Also, according to another embodiment of the present invention, the method of providing navigation background information may display a corresponding image according to a predetermined order by including the image in the navigation background information. In this instance, the order refers to an order of loading an image corresponding to the peak ID in an order of farthest to nearest distance.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

According to the present invention, a method of providing navigation background information and a navigation system using the same load an image with respect to a peak, which is included in a predetermined distance range and a predetermined visual field angle, by referring to a current location of a vehicle and location information about each peak, include the image in the navigation background information, and thereby may provide the navigation background information in a more realistic manner.

Also, according to the present invention, a method of providing navigation background information and a navigation system using the same control an image with respect to a peak, included in the navigation background information, to be displayed with perspective, based on a distance between a vehicle and the peak, and thereby may provide navigation background information in a more realistic manner.

1. A navigation system, comprising:
a peak point database storing corresponding location information for each peak identifier (ID);
a distance/angle computation unit computing distance information and angle information between a vehicle and a peak by referring to the peak point database and current location information of the vehicle;
an image loading unit loading an image corresponding to the peak ID from a predetermined image database, when the computed distance information and angle information are included in a predetermined distance range and a predetermined visual field angle;
an image control unit controlling the loaded image based on a distance between the vehicle and the peak; and
a background information generation unit generating navigation background information including the controlled image.

2. The navigation system of claim 1, wherein the image loading unit includes at least one peak ID, included in the predetermined distance range and the predetermined visual field angle, in a display list, and loads an image corresponding to each of the at least one peak ID included in the display list in an order of farthest to nearest distance.

3. The navigation system of claim 2, wherein the background information generation unit displays a corresponding image according to the order by including the image in the navigation background information.

4. The navigation system of claim 3, wherein the navigation background information is provided as a portion of navigation information associated with the vehicle.

5. The navigation system of claim 1, wherein the distance/angle computation unit computes the distance information and the angle information between the vehicle and the peak by considering a driving direction of the vehicle.

6. The navigation system of claim 1, wherein the image control unit controls a height of the image based on the distance between the vehicle and the peak.

7. The navigation system of claim 1, wherein the image control unit controls a predetermined portion of the image to be displayed, based on the distance between the vehicle and the peak.

8. The navigation system of claim 7, wherein the image control unit controls an upper portion of the image to be displayed when the distance between the vehicle and the peak is equal to or greater than a predetermined distance, and controls the image to be entirely displayed when the distance between the vehicle and the peak is less than the predetermined distance.

9. The navigation system of claim 1, wherein the image database generates and stores an image for each peak ID, and the image loading unit loads the image corresponding to the peak ID from the image database.

10. The navigation system of claim 1, wherein the location information stored in the peak point database is generated using an altitude point of the peak by referring to a contour line data of the peak.

11. A method of providing navigation background information, the method comprising:
maintaining a peak point database storing corresponding location information for each peak ID;
computing distance information and angle information between a vehicle and a peak by referring to the peak point database and current location information of the vehicle;
loading an image corresponding to the peak ID from a predetermined image database, when the computed distance information and angle information are included in a predetermined distance range and a predetermined visual field angle;
controlling the loaded image based on a distance between the vehicle and the peak; and
generating navigation background information including the controlled image.

12. The method of claim 11, wherein the loading includes at least one peak ID, included in the predetermined distance range and the predetermined visual field angle, in a display list, and loads an image corresponding to each of the at least one peak ID included in the display list in an order of farthest to nearest distance.

13. The method of claim 12, wherein the generating displays a corresponding image according to the order by including the image in the navigation background information.

14. The method of claim 13, wherein the navigation background information is provided as a portion of navigation information associated with the vehicle.

15. The method of claim 11, wherein the computing computes the distance information and the angle information between the vehicle and the peak by considering a driving direction of the vehicle.

16. The method of claim 11, wherein the controlling controls a height of the image based on the distance between the vehicle and the peak.

17. The method of claim 11, wherein the controlling controls a predetermined portion of the image to be displayed, based on the distance between the vehicle and the peak.

18. The method of claim 17, wherein the controlling controls an upper portion of the image to be displayed when the distance between the vehicle and the peak is equal to or greater than a predetermined distance, and controls the image to be entirely displayed when the distance between the vehicle and the peak is less than the predetermined distance.

19. The method of claim 11, wherein the image database generates and stores an image for each peak ID, and the loading loads the image corresponding to the peak ID from the image database.

20. The method of claim 11, wherein the location information stored in the peak point database is generated using an altitude point of the peak by referring to a contour line data of the peak.

21. A computer-readable recording medium storing a program for implementing the method according to any one of claims 11 through 20.
